(19) United States
(12) Patent Application Publication
(10) Pub. No.: US 2017/0082582 A1
(43) Pub. Date: Mar. 23, 2017

(54) Simulation-Supported Defect Evaluation Using Ultrasound

(71) Applicant: Siemens Aktiengesellschaft, Muenchen (DE)

(72) Inventors: Karl Fendt, Wien (AT); Hubert Mooshofer, Muenchen (DE); Stefan Johann Rupitsch, Nuernberg (DE)

(73) Assignee: Siemens Aktiengesellschaft, Muenchen (DE)

(21) Appl. No.: 15/308,503

(22) PCT Filed: Apr. 23, 2015
(86) PCT No.: PCT/EP2015/058789

§ 371 Date: Nov. 2, 2016

(30) Foreign Application Priority Data
May 22, 2014 (DE) 10 2014 209 773.8

(51) Int. Cl. G01N 29/44; G01S 15/89; G01S 7/52; G01N 29/06; G01N 29/11

(52) U.S. Cl. CPC G01N 29/4472; G01N 29/069; G01N 29/0672; G01N 29/11; G01N 29/4418; G01S 7/52052; G01S 15/8997; G01N 2291/015; G01N 2291/2693

(57) ABSTRACT

An ultrasound device for examining a component may include a measuring device for performing an ultrasonic measurement of the component and an analysis device. The ultrasound device may be designed to quantify structural elements, such as defects, in the component. For this purpose, the analysis device may be designed to determine a number and a respective position of at least one internal structural element of the component as a function of the ultrasonic measurement data from the measuring device using a reconstruction method, and to use a simulator to determine at least one character of each structural element by simulating the ultrasound measurement and adapting each model as a function of each ascertained position using a respective model for the at least one structural element.

### CROSS-REFERENCE TO RELATED APPLICATIONS

This application is a U.S. National Stage Application of International Application No. PCT/EP2015/058789 filed Apr. 23, 2015, which designates the United States of America, and claims prority to DE Application No. 10 2014 209 773.8 filed May 22, 2014, the contents of which are hereby incorporated by reference in their entirety.

### TECHNICAL FIELD

The invention relates to a method for examining a component. To this end, nondestructive inspection is performed by emitting ultrasound into the component and recording signals of the ultrasound echo. The invention also comprises an examination apparatus for performing the method according to the invention.

### BACKGROUND

In nondestructive testing of safety-critical components with the aid of ultrasound, besides finding a defect, the quantification thereof in relation to at least one characteristic of the defect is also of crucial importance. For example, for mechanical fracture examination, monitoring of crack growth and estimation of a component lifetime, knowledge of the position, size and/or shape of existing defects is necessary.

Size evaluation of a defect is possible by means of direct ultrasound measurement only when the defect is sufficiently large in relation to the sound beam width and the wavelength of the ultrasound used. Then, for example, visualization of the defect can be generated by means of an imaging method and the defect size can be determined thereon. For small defects, which are for example smaller than twice the wavelength of the ultrasound, these methods can no longer be used since in this case the imaging properties of the method dominate and a sufficiently fine spatial resolution is not possible. One exemplary application case for the evaluation of small defects is the testing of rotor components in power mechanical engineering.

An additional problem is encountered when it is not a single defect which is present in the component, but rather a plurality of defects and therefore a plurality of scattering centers or scattering cores for the ultrasound. Interactions due to multiple scattering between neighboring defects generally lead to incorrect evaluations. Furthermore, the superimposition of defect echoes of neighboring inhomogeneities, or the superimposition of defect echoes with structural scattering, generally lead to erroneous or inaccurate evaluation.

### SUMMARY

One embodiment provides a method for examining a component, comprising the steps of performing an ultrasound inspection by emitting ultrasound into the component and recording ultrasound measurement values from the component, as a function of the ultrasound measurement values, generating a reconstruction of an internal structure of the component by means of a predetermined reconstruction method, in the reconstruction, determining a number and a respective position of at least one structural element of the internal structure, according to the respective position, positioning a respective model of each structural element in a simulation model of the component, each model comprising at least one adjustable model parameter which describes a characteristic of the respective structural element by means of the simulation model, simulating the ultrasound inspection and thereby generating simulation values, determining a difference between the simulation values and the ultrasound measurement values, as a function of the difference, modifying each model parameter according to an optimization rule designed to reduce the difference.

In one embodiment, at least one model comprises at least one model parameter comprises: a shape of the modeled structural element, a reflection factor, an attenuation factor, an alignment or orientation in the component, a position in the component.

In one embodiment, in at least one model, a maximum dimension of the structural element is less than a doubled wavelength of the ultrasound, e.g., less than 1.5 times the wavelength.

In one embodiment, the reconstruction method is an imaging method and preferably comprises at least one of the following methods: synthetic aperture focusing technique, deconvolution imaging, total focusing method.

In one embodiment, determination of the respective position comprises localization of a local maximum and/or a deconvolution.

In one embodiment, the simulation comprises at least one of the following simulation methods: point source synthesis, finite difference time domain method, finite element method, finite integration technique.

In one embodiment, the determination of the difference comprises the calculation of a sum of squares of differences between respectively a simulation value and an ultrasound measurement value simulated by the latter.

In one embodiment, the optimization rule comprises at least one of the following methods: gradient descent method, Gauss-Newton method, Monte Carlo method, parameter studies.

In one embodiment, the simulation of the ultrasound measurement and the modification of each model parameter are performed iteratively until the difference determined satisfies a predetermined optimization criterion.

In one embodiment, a model type of each model is established as a function of a property of the component.

Another embodiment provides an examination apparatus for examining a component, the examination apparatus comprising a measuring device for performing an ultrasound measurement on the component and an analysis device, wherein the analysis device is configured in order to determine a number and a respective position of at least one internal structural element of the component as a function of ultrasound measurement data of the measuring device by means of a reconstruction method and to determine by means of a simulator at least one characteristic of each structural element as a function of each position determined, with the aid of a respective model for the at least one structural element, by simulating the ultrasound measurement and adapting each model as a function of the ultrasound measurement values.

### BRIEF DESCRIPTION OF THE DRAWINGS

Example aspects and embodiments of the invention are described below with reference to the figures, in which:

FIG. 1 shows a schematic representation of an embodiment of the examination apparatus according to an example embodiment of the invention,

FIG. 2 shows a flowchart which describes an example sequence of one embodiment of the method, which may be performed by the example examination apparatus of FIG. 1, and

FIG. 3 shows a flowchart of a method step of the example method of FIG. 2.

### DETAILED DESCRIPTION

Embodiments of the invention may be configured to quantify structural elements, for example defects, in a component.

Some embodiments provide a method to quantify structural elements, e.g., defects, in a component. An (imaging) reconstruction method is applied to measurement values of an ultrasound inspection. In this case, an existing data set may be employed or a new ultrasound measurement may be performed. An ultrasound measurement is intended to mean the emission of ultrasound into the component and the recording of ultrasound signals by the emitter unit, or at least one receiver unit. In the second step, the number of defects and the approximate position are extracted from the reconstruction, i.e. from the image data. The position specification may respectively describe a 1D position, a 2D position or a 3D position. In the last step, with the aid of the extracted information, an inverse method for reconstruction of the ultrasound measurement values is applied. The invention relates not only to the defect detection, but also in general to the examination of an internal structure of a component.

In some embodiments, the internal structure of the component comprises at least one structural element. A structural element is in the context of the invention generally intended to mean a scattering core or scattering center or a reflection surface for the ultrasound, i.e. an inhomogeneity in the material of the component. One example of an internal structural element is a defect, for example a hairline crack, a material inclusion or a corroded position or an interface between two parts of the component.

For the case in which a structural element has dimensions of the order of the wavelength of the ultrasound (in particular less than twice the wavelength), i.e. the maximum dimension of the scattering element is correspondingly small, it is to be assumed that the structural element is not imaged sharply enough in the reconstruction to determine a characteristic of the structural element. The method according to the invention therefore does not rely on this reconstruction. Instead, only the number and a respective position of at least one structural element of the internal structure in the reconstruction are determined. The number and the approximate positions of structural elements are therefore revealed by the method.

Next, according to the respective position of each structural element, a model of each structural element is respectively positioned in a simulation model of the component. Each model in this case comprises at least one adjustable model parameter, which describes a characteristic of the respective structural element. One very simple model may for example describe the structural element as a circular disk, in which case a diameter and/or a spatial alignment of the circular disk in the component may for example be specified as a characteristic. By means of the simulation model, the ultrasound measurement is simulated in the method, that is to say the emission of the ultrasound, scattering processes and the reception of the scattering signals are simulated in the simulation. In this way, simulation values are generated. Simulation values describe, in particular, those ultrasound measurement values which would have to have occurred if structural elements that have the characteristic as specified by each model were actually present in the component. If each model describes the respective structural element in the component accurately enough, then the simulation values would have to coincide with the ultrasound measurement valves. In order to check this, a difference between the simulation values and the ultrasound measurement values is determined. As a function of the difference, each model parameter is then modified according to an optimization rule. This optimization rule is designed to reduce the difference. To this end, preferably, a gradient descent method and/or a Gauss-Newton method, in particular a regularized Gauss-Newton method, is used as a basis for the optimization rule. Two other suitable approaches are a Monte Carlo method and parameter studies. In other words, when there is a difference, at least one model parameter in each model is adapted according to the selected optimization rule, so that in this way the model describes the characteristic of the respective structural element more accurately.

Thus, some embodiments may provide the advantage that, after the modification of the model parameters according to the optimization rule, for each structural element there is a model whose model parameter describes the characteristic of the respective structural element more accurately than before the optimization step.

In some embodiments, the simulation of the ultrasound measurement and the modification of each model parameter are performed iteratively until the difference determined satisfies a predetermined optimization criterion. For example, a threshold value may be set for the difference and the adaptation of the model parameters may be performed until the difference is smaller in magnitude than the threshold value. By adjusting the threshold value, it is therefore possible to adjust to a desired accuracy factor the accuracy with which the adjustable parameters of each model describe the characteristic of the associated structural element.

As a suitable measure for optimizing the model parameters, it has been found appropriate to use the calculation of a sum of squares of differences between respectively a simulation value and an ultrasound measurement value replicated or described or simulated by the latter as a basis for determining the difference. Minimization of the sum of squares, i.e. a minimum mean square error method, has shown a reliable convergent behavior in connection with the described optimization.

In relation to the model used, provision is made that at least one model comprises at least one of the following parameters as a model parameter: comprises: a shape of the modeled structural element, a reflection factor, an attenuation factor, an alignment or orientation in the component, a position in the component. A simple geometrical base shape may for example be used as a basis for the shape, for example spherical shape or an ellipsoid shape or the shape of a circular disk. Alternatively, for example, on the basis of previous examinations, including for example with other test methods (for example X-ray testing), a prototype for e.g. a known typical defect in the component, for example a hairline crack, may be used as a basis for the shape. The position of the structural element may likewise be corrected by means of the method on the basis of the difference determined.

In order to determine the characteristic of a structural element with particularly little outlay, the selection of a suitable model may be established beforehand as a function of a property of the component. In other words, the model type is thus selected as a function of which type of structural element is expected in the component. If it is for example assumed that hairline cracks could be present in the component, then a corresponding defect model for a hairline crack may be used. Particularly in the iterative embodiment of the method, the convergence of the method is advantageously accelerated by means of this.

In order to determine the number and the position of individual structural elements on the basis of the ultrasound measurement values, an imaging method is preferably used as the reconstruction method. In particular, the following methods and/or combinations of these methods have been found appropriate for this: synthetic aperture focusing technique, deconvolution imaging and total focusing method. Algorithms for performing these methods are available in the prior art and may advantageously be integrated with little adaptation outlay into the method according to the invention.

As a result of the reconstruction, an image of the internal structure of the component is obtained, although, as already described, in particular defects with a maximum dimension of the order of the wavelength of the ultrasound are not imaged with sufficient imaging accuracy. In order to determine the position of a structural element reliably despite this, the position of a local maximum in the image may be used as a localization method. The localization of local maxima in images may be performed by means of an image analysis method known per se. In addition or as an alternative to the maximum localization, an autocorrelation method, as is likewise known per se from the prior art, may also be used as a basis.

In order to be able to combine a plurality of models of structural elements in a simulation model and obtain reliable simulation values therefrom, in the context of the method according to the invention it has been found appropriate for the simulation to comprise at least one of the following simulation methods: a point source synthesis, a finite difference time domain method, a finite element method, a finite integration technique.

As already mentioned, the invention also comprises an examination apparatus for the inspection of a component. The examination apparatus comprises the described measuring device for performing an ultrasound measurement on the component and an analysis device.

The analysis device may for example be formed as a processor device, for example a computer, or as a program module for such a processor device.

The analysis device is configured in order to determine a number and a respective position of at least one internal structural element of the component, i.e. for example a respective defect or for example also a boundary, transition surface between two elements of the component, as a function of ultrasound measurement data of the measuring device by means of a reconstruction method. The analysis device furthermore comprises a simulator, by means of which at least one characteristic and/or accurately specified position of each structural element is determined with the aid of a respective model for the at least one structural element, by simulating the ultrasound measurement and adapting each model as a function of the ultrasound measurement values on the basis of the simulation values. In this way, models for the structural elements are finally obtained, each of which describes the characteristic of one of the structural elements.

The embodiment explained below is one example embodiment of the invention. In the exemplary embodiment, however, the described components of the embodiment respectively represent individual features of the invention, which are to be considered independently of one another, and which also independently of one another respectively refine the invention and therefore are to be regarded as part of the invention individually or in any combination other than that shown. Furthermore, the embodiment described may also be supplemented with other ones of the already described features of the invention.

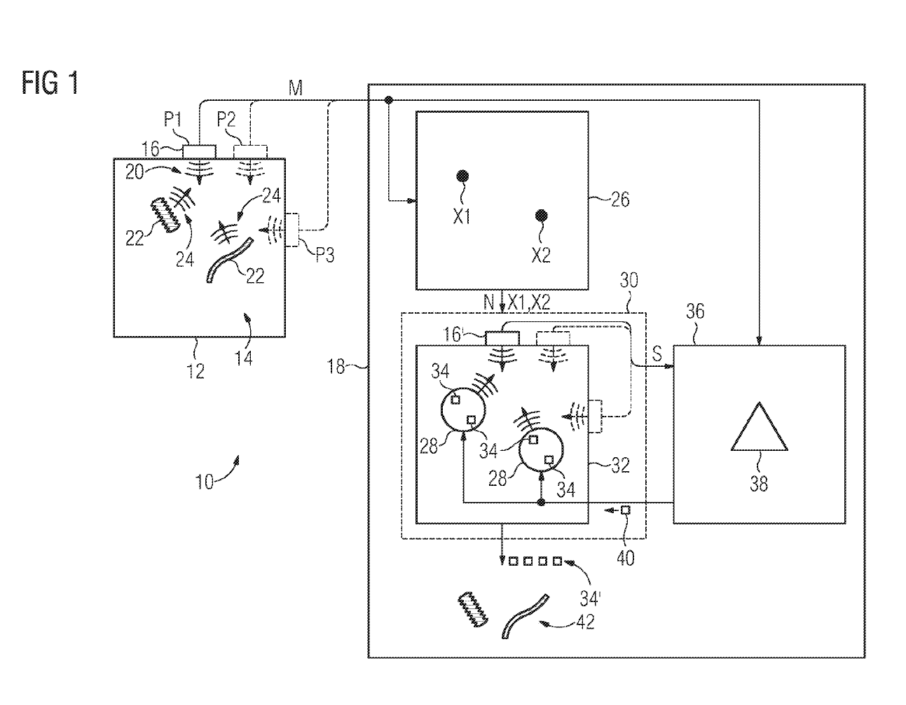

FIG. 1 represents an examination apparatus 10 with which, for a component 12, the internal structure 14 of the latter can be examined noninvasively or nondestructively, according to an example embodiment. The examination apparatus 10 may comprise an ultrasound measuring device, or measuring device for short, 16 and an analysis device 18.

The measuring device 16 may be formed in a manner known per se and configured in order to radiate or emit an ultrasound signal or ultrasound 20 into the component 12. The measuring device may also comprise a separate ultrasound emitter and receiver unit. By structural elements 22 which may lie inside the component 12 and which represent the internal structure 14, ultrasound may be reflected or scattered at the structural elements 22, i.e. echoes 24 of the ultrasound 20 may be produced. The measuring device 16 may be configured in order to record the echoes 24 and to generate ultrasound measurement values, or measurement values for short, M in a manner known per se for the recorded echoes 24. In FIG. 1, the measuring device 16 is arranged at a first measuring position P1 on the component 12. In order to generate the measurement values M, the measuring device may also be arranged at a plurality of different positions P2, P3 and further positions (not illustrated) on the component 12.

The measurement values M may be transmitted to the analysis device 18, for example by a data line or, for example, by transporting the measurement values M by means of a portable data medium.

The structural elements 22 may, for example, respectively be an inclusion, a hairline crack or a corrosion position or another defect in the component 12, or in general a scattering center or a reflection surface for the ultrasound 20.

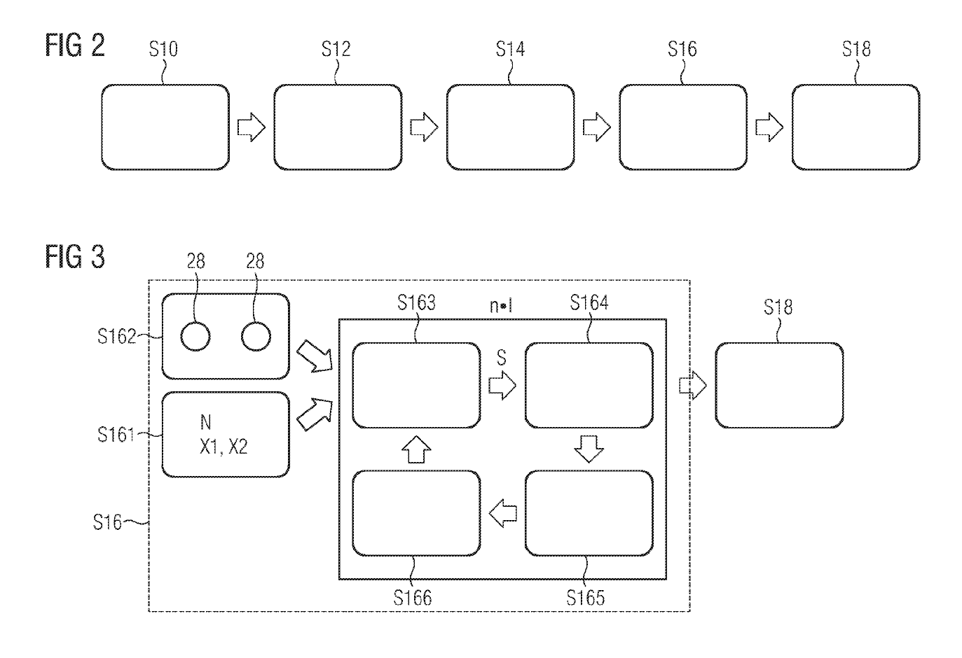

By means of the analysis device 18, a characteristic may be determined for each structural element 22, for example the size of the structural element 22 or one or more of the other characteristics already described. To this end, the method described below with the aid of FIG. 2 and FIG. 3 is performed in the analysis device 18 on the basis of the measurement values M.

According to FIG. 2, in the course of the component inspection with ultrasound, that is to say with the generation of the measurement values M in the measurement step S10, by means of an imaging method in step S12 a reconstruction 26 of the internal structure 14, i.e. an image of the internal structure 14, is generated. For example, the reconstruction 26 may be reconstructed with the aid of a synthetic aperture focusing technique (SAFT). From the reconstruction data of the reconstruction 26, in a step S14 a number N (in the example, N=2) and a position X1, X2 of each structural element 22 recognizable in the reconstruction 26 can be determined, in particular to the extent that they have in the reconstruction a signal identity which lies above a noise level by a predetermined signal-to-noise ratio.

These positions X1, X2 which have been determined may form starting parameters for a simulation to be performed in step S16. Besides the described position X1, X2 for each structural element, further starting parameters may also be extracted as a function of the corresponding suitability of the reconstruction 26 used.

In the step S16, further characterization values, that is to say for example defect parameters, of the structural elements 22 are determined by an inverse method, by approximating the recorded measurement values M with a simulated data set of simulation values S. Here, inverse means that the measurement values M are intended to be reconstructed.

The operation of the simulator 30 is illustrated in FIG. 3. The starting point for both the number N and a first estimated position X1, X2 of the modeled defects, that is to say of respective models of the structural elements 22, may be the results of the preceding step in an initialization step S161. The choice of the model 28 may be selected in a step S162 as a function of the type of structural elements to be expected, for example the defect to be expected, for example because of the production process or the loading of the component 12, and the inspection modality used, that is to say the properties of the measuring device 16.

The defect geometry, or in general structural geometry, may be described by a simplified model, for example a circular disk, sphere or an ellipsoid, in order to reduce the number of degrees of freedom during the optimization and therefore facilitate convergence of the optimization process. FIG. 1 illustrates the way in which, in this case, a spherical model is respectively provided for each structural element 22 in a first simulation as models 28 in a simulation model 32 of the component 12. Each model 28 however comprises an adjustable parameter 34, which may for example describe a shape of the structural element modeled by the model 28 and a spatial orientation in the simulation model 28.

The selected models 28 are integrated into the simulation model 32, or positioned, in a simulator 30 according to the positions X1, X2 which have been determined, and the ultrasound measurement is simulated by the simulator 30, that is to say a simulation is performed of how a virtual measuring device 16′, which may have the properties of the measuring device 16, in the described way emits ultrasound into the component 12 and receives it therefrom. In the simulator 30, the component 12 is the simulation model 32.

By the simulation, simulation values S are thereby generated in a manner known per se. By means of the simulator 30 and an optimization unit 36, iterative optimization of the model parameters 34 can now be performed, with the aim of minimizing a difference 38 (illustrated by a delta in the image) between the measurement values M and the simulation values S. To this end, the optimization unit 36 generates update values 40 for the model parameters 34, so that a simulation can be performed again with the modified parameter values 34.

In one specific implementation of the simulator 30, the simulation may for example be performed in point source synthesis and the optimization may be performed with the aid of an iterative regularized Gauss-Newton method. In principle, however, any desired simulation and optimization methods may be applied. The goal functional of determining the difference 38 may, in the simplest case, consist of the sum of squares of deviation between simulation and measurement. The model parameters 34 may be modified several times that is to say n iterations I may be performed until the correspondence of simulation and measurement is sufficient according to a predetermined optimization criterion. To this end, the simulation is thus performed in the scope of a plurality of iterations nI in a simulation step S163, which leads to current simulation values S, the goal functional, i.e. the difference 38, is determined in a comparison step S164, the local derivative of the error function which has been used to calculate the difference 38 is quantified in an optimization step S165, and the parameter update, is performed therefrom in an optimization step S166, i.e. the update values 40 are entered into the model parameters 34 of the models 28.

If the optimization criterion is then satisfied after n iterations, the values of the model parameters 34 may be read out in a step S18. These final parameters 34′ which have been read out may describe the quantified defects. In other words, the final parameters 34′ may be read out from the models 28 and descriptions 42 of the quantified structural elements may be formed therefrom, and the latter may for example be represented to a user on a display device.

Instead of the aforementioned methods, the following methods may also be used in the scope of the individual method steps S12 to S16:

Method step S12:

SAFT, diffraction tomography, deconvolution imaging, total focusing method.

Method step S14:

Determination of local maxima, deconvolution.

Method step S16:

Simulation methods: point source synthesis, finite difference time domain, finite elements;

and as optimization methods: regularized Gauss-Newton method, method of conjugated gradients.

The aforementioned embodiments are, however, to be understood only by way of examples.

In particular, the described combination of imaging methods with an inverse method on the basis of a simulation is provided. In particular, initial parameters for the simulation are determined by using a SAFT, and then defect parameters are determined in the simulation by means of a point source synthesis with iteratively regularized Gauss-Newton optimization. The method according to the invention provides in this case, in particular, for the ultrasound testing of wheel disks and wheel shafts, such as are used for example in turbines, generators or in general heavily loaded steel products.

The method may, however, also be used for example in the scope of an ultrasound examination of a body. In this case, the person's or animal's body being examined is then to be regarded as a component.

By the described combination of an imaging method and a simulation method, it is possible to quantify correctly neighboring structural elements or defects, the scattering signals of which in conventional methods influence one another and are therefore evaluated erroneously. The only prerequisite in this case is that two structural elements can still be resolved as separate elements in step S12 with the imaging method applied. By use of a suitable simulation method, the proposed method also makes it possible to take multiple scattering, i.e. the interaction of neighboring defects into account in the defect evaluation. In conventional size evaluation of structural elements or defects, each A-image, i.e. the signal at a measurement position, needs to be evaluated separately. In contrast therewith, in the proposed method all positions from which the defect position is insonated are simultaneously included in the evaluation. In this way, more information is taken into account, and the structural noise as well as interfering signals are reduced, suppressed or compensated for.

By a plurality of measurement positions P1, P2, P3 being taken into account, the signal-to-noise ratio of the evaluation is also improved, which makes it possible to detect and evaluate even particularly small defects.

Inspection results are conventionally documented not as an image but in the form of a so-called display table with description of the displays. This step may be performed automatically by the analysis device 18 in the form of the final parameters 34′ which have been determined for the structural elements 22.

In the imaging method, many other factors besides potential defects may have an influence on the result. Examples thereof are the test frequency, sound field characteristic and signal shapes. Determination of the relevant inspection data such as defect size and shape is therefore often nontrivial. The proposed method can take into account and/or correct such influences by a corresponding simulation model during the simulation. Furthermore, it is also possible to determine defect parameters, i.e. the model parameters 34, for example the defect orientation, which are not readily apparent from a reconstruction image 26 or the raw data, that is to say the measurement data M. Known influencing factors, for example the component shape or anisotropy, may be taken into account in the scope of the simulation by corresponding selection of the simulation model 32.

Overall, the example shows the way a model-based ultrasound defect evaluation can be performed with the invention.

What is claimed is:

1. A method for examining a component, the method comprising:
performing an ultrasound inspection by emitting ultrasound into the component and recording ultrasound measurement values from the component,
generating a reconstruction of an internal structure of the component based on the ultrasound measurement values using a predetermined reconstruction process,
determining, from the reconstruction, a number and a respective position of at least one structural element of the internal structure,
based on the respective position of each structural element of the internal structure, positioning a respective model of each structural element in a simulation model of the component, each model comprising at least one adjustable model parameter which describes a characteristic of the respective structural element
by means of the simulation model, simulating the ultrasound inspection and thereby generating simulation values, wherein the simulation values represent ultrasound measurement values that would occur if the component embodied the structural elements having the characteristic specified by each model,
determining a difference between the simulation values and the ultrasound measurement values, and
based on the difference, modifying each model parameter according to an optimization rule configured to reduce the difference.

2. The method of claim 1, wherein, at least one model comprises at least one of the following model parameters: a shape of the modeled respective structural element, a reflection factor, an attenuation factor, an alignment or orientation in the component, or a position in the component.

3. The method of claim 1, wherein, in at least one model, a maximum dimension of the structural element is less than a two times a wavelength of the ultrasound.

4. The method of claim 1, wherein the reconstruction process is an imaging process and comprises at least one of the following methods: a synthetic aperture focusing technique, deconvolution imaging, and a total focusing method.

5. The method of claim 1, wherein determination of the respective position comprises localization of at least one of a local maximum or a deconvolution.

6. The method of claim 1, wherein the simulation comprises at least one of the following simulation methods: point source synthesis, finite difference time domain method, finite element method, or finite integration technique.

7. The method of claim 1, wherein the determination of the difference comprises calculating a sum of squares of differences between a simulation value and an ultrasound measurement value simulated by the latter.

8. The method of claim 1, wherein the optimization rule comprises at least one of the following methods: gradient descent method, Gauss-Newton method, Monte Carlo method, or parameter studies.

9. The method of claim 1, wherein the simulation of the ultrasound measurement and the modification of each model parameter are performed iteratively until the difference determined satisfies a predetermined optimization criterion.

10. The method of claim 1, wherein a model type of each model is established as a function of a property of the component.

11. An examination apparatus for examining a component, the examination apparatus comprising:
performing, by a measuring device, an ultrasound measurement on the component;
determining, by an analysis device, a number and a respective position of at least one internal structural element of the component based on ultrasound measurement data of the measuring device using a reconstruction method, and
determining, by a simulator of the analysis device, at least one characteristic of each structural element of the component based on the respective position of the respective internal structural element, using a respective model for the respective structural element, by simulating the ultrasound measurement and adapting each model as a function of the ultrasound measurement values.
